(19) United States
(12) Patent Application Publication
(10) Pub. No.: US 2014/0333782 A1
(43) Pub. Date: Nov. 13, 2014

(54) VIEW-ASSISTED IMAGE STABILIZATION SYSTEM AND METHOD

(71) Applicants: Venkatraman Narasimhan, Plano, TX (US); Veeramanikandan Raju, Bangalore (IN)

(72) Inventors: Venkatraman Narasimhan, Plano, TX (US); Veeramanikandan Raju, Bangalore (IN)

(73) Assignee: TEXAS INSTRUMENTS INCORPORATED, Dalas, TX (US)

(21) Appl. No.: 13/889,297

(22) Filed: May 7, 2013

(51) Int. Cl. H04N 5/232

(52) U.S. Cl. CPC H04N 5/23264; H04N 5/23254
USPC 348/208.1

(57) ABSTRACT

A video device includes a first video camera, a second video camera, a motion estimating portion and an image stabilization portion. The first video camera records a first image of a first field of view, records a second image of the first field of view, outputs a first frame of image data based on the first image and outputs a second frame of image data based on the second image. The second video camera records a third image of a second field of view, records a fourth image of the second field of view, outputs a third frame of image data based on the third image and outputs a fourth frame of image data based on the fourth image. The motion estimating portion outputs a motion signal based the fourth frame of image data. The image stabilization portion modifies the second frame of image data based on the motion signal.

### BACKGROUND

Image stabilization technology compensates for the motion of a user when recording video of a subject. For example, if the user is trying to record a play, the user's hand may move during the recording. Image stabilization compensates for the motion of the user's hand and stabilize the video of the play, such that it does not look like the video “jumps” due to the motion of the user's hand.

In conventional image stabilization methods, objects of reference are used as reference points to determine whether image stabilization should be applied. In many cases, objects of reference may be taken from the background or the edges of the field of view. In some cases, objects or reference are determined based on a comparison of a number of consecutive image frames, wherein the objects that do not change position are determined to be an object of reference. In short, the objects of reference are used as reference points, whose coordinates within an image, are used to establish a static field of view. Movement of the field of view is determined when the positions of the objects of reference, respectively, changes from one image frame to the next image frame, but the positions of the objects of reference relative to one another does not change from one image frame to the next image frame.

Mechanical image stabilization refers to stabilization of the camera to compensate for hand movement. In mechanical image stabilization, the camera is equipped with additional mechanical features to physically counteract hand motion of the user recording the video. Examples of mechanical image stabilization include lens-based stabilization and sensor-shift stabilization.

Digital image stabilization refers to stabilization of the image after it has been recorded. In digital image stabilization, the image data as recorded by the camera is modified electronically to compensate for hand motion of the user recording the video. The focus of this invention is on digital image stabilization.

If there is movement of the field of view, it may be attributed to movement of the video camera, e.g, the camera operator's hand is shaking. If there is movement of the video camera, then the recorded image will have movement, e.g., the video will be shaking. To minimize video shaking, digital image stabilization is applied.

One known method of digital image stabilization is drawn to consecutive image frame comparisons, wherein an image of a first frame is compared with an image of a consecutive frame, or frames. Each image may be divided into smaller areas, maybe even down to pixels, wherein corresponding areas between the two consecutive images are compared. Similarities within the two images may be used to determine objects of reference. At that point, subsequent image frames are again divided, wherein differences between the positions of the objects of reference may be used to determine a motion of the field of view in an x-y coordinate system. Once the motion of the field of view is determined in an x-y coordinate system, an opposite “motion” may be applied to the recorded image. In effect, the pixels for an image may be shifted in a direction opposite to the direction corresponding to the motion of the field of view. This shift in the image pixels counters what would have been a shift in the image, thus avoiding “shake in the image,” thus providing the image stabilization. As the number of sub-divisions in the images increases (for purposes of comparison to determine how much, if any, image stabilization is required), the image stabilization increases. However, as the number of sub-divisions in the images increases, the amount of processing resources additionally increases. As such, a common decision when designing a conventional image frame comparison digital image stabilization system is whether to have an increase image stabilization that consumes much processing resources or to have decreased image stabilization that consumes less processing resources.

Another problem with the conventional method of comparing consecutive frames for image stabilization deals with reference objects that move. In such cases, conventional digital image stabilization systems may not correctly distinguish between motion of the user and motion of the subject. This issue will be further described with reference to FIGS. 1-4.

FIG. 1 illustrates a scenario where a video is being recorded. As shown in the figure, the scenario includes a videographer 102, a subject 104, a fan 106 having fan blades 108-112, and a video recorder 114.

Videographer 102 is recording a video of subject 104 using video recorder 114. Fan 106 is present in the background of the video being recorded, such that fan 106 is being recorded along with subject 104. Fan 106 is turned on, such that fan blades 108, 110 and 112 are rotating.

FIGS. 2A-C illustrate images recorded by video recorder 114. FIGS. 3A-C illustrate images, which correspond to the images of FIGS. 2A-C, respectively, and which have been processed using digital image stabilization for display or storage. FIG. 4 illustrates a detailed view of video recorder 114 of FIG. 1.

As shown in FIG. 4, video recorder 114 includes video camera 402, motion estimate portion 404, image stabilization portion 406, actuation portion 408, memory portion 410, display portion 412 and controller 414.

Video recorder 114 may be any device that includes a camera to record video. In this example, video recorder 114 may be a mobile phone with a front facing camera. Those skilled in the art will understand that other devices (tablet computers, handheld camcorders, etc.) may include a camera as well.

Video camera 402 may be any type of camera designed to capture video. Video camera 402 is preferably small enough to fit in a device like a mobile phone, such that the user does not have to carry a video recording device separate from a mobile phone. In this example, first video camera 402 may be a CMOS camera similar to those used in mobile phones.

Motion estimate portion 404 is arranged to receive image data 416 from video camera 402. Motion estimate portion uses image data 416 to determine if image stabilization is required. The motion may be estimated by any conventional motion estimation methods, including direct methods or algorithms (block-matching, phase correlation, pixel recursive, MAP/MRF, optical flow) and indirect methods or algorithms (corner detection, face recognition). Based on image data 416, motion estimate portion 506 will determine how much undesired motion is being introduced, and create motion signal 420 and send it to image stabilization portion 406.

Image stabilization portion 406 is arranged to receive motion signal 420 from motion estimate portion 404. Motion signal 420 will provide input to image stabilization portion 406 and based on the input, image stabilization portion 406 will either attempt to stabilize the video being recorded or not stabilize the video being recorded. Image stabilization portion 406 may use any conventional methods know by those of ordinary skill in the art to stabilize the video, such as optical image stabilization, sensor-shift, digital image stabilization and stabilization filters. Once image stabilization portion 406 has completed the stabilization process, stabilized video 422 is sent to both memory portion 410 and display portion 412.

Actuation portion 408 is arranged to communicate with image stabilization portion 406. Actuation portion provides the user the ability to turn on/off image stabilization portion 406 by sending actuation signal 418, in case the user does not wish to have image stabilization portion 406 turn on automatically.

Memory portion 410 is arranged to communicate with image stabilization portion 406 and receive stabilized video 422 for future viewing by the user. Non limiting examples of memory portion 410 include RAM, ROM, EEPROM, CD-ROM or other optical disk storage, magnetic disk storage or other magnetic storage devices, or any other medium which can be used to carry or store desired program code means in the form of data structures which can be accessed by a general purpose or special purpose computer.

Display portion 412 is arranged to communicate with image stabilization portion 406 and receive stabilized video 422 for viewing while the video is being recorded. Non-limiting examples of display portion 412 include a mobile phone screen, tablet computer screen, television, laptop or desktop computer screen, or any other device which has the capability of displaying the video as it is recorded on video recorder 114.

Controller 414 is arranged to bidirectionally communicate with each of video camera 402, motion estimate portion 404, image stabilization portion 406, actuation portion 408, memory portion 410 and display portion 412. Controller 414 may receive instructions from the user via a graphical user interface (GUI—not shown), and pass the instructions from the user to each of the portions of video recorder 114.

FIG. 2A illustrates a first frame corresponding to a first image 200 recorded by video camera 402 of video recorder 114 at a time t₁.

As shown in FIG. 2A, an image window 218 includes image 200, which includes an image portion 202 corresponding to subject 104 of FIG. 1 and an image portion 204 corresponding to fan 106 of FIG. 1. Image portion 204 includes image portions 206, 208 and 210, which correspond to fan blades 110, 112 and 108, respectively of FIG. 1. Still further, image portion 210 includes reference objects 212, 214 and 216. An image portion 220 corresponds to the portion of subject 104, which is disposed outside of image 200. An image portion 222 corresponds to the portion of fan 106, which is disposed outside of image 200.

In the first frame of video being recorded, fan blades 108, 110 and 112 are in a first position. Video recorder 114 may be equipped with digital image stabilization, in which case the specific objects of reference are chosen, upon which estimates of any movement of the hand of videographer 102 will be based. In the case of this example, camera 114 chooses reference objects 212, 214 and 216 as the objects of reference.

As shown in FIG. 4, video camera 402 may then display an image corresponding to this first frame on display portion 412 or may store the image corresponding to this first frame in memory portion 410. This will be described with reference to FIG. 3A.

FIG. 3A illustrates a first image 300, corresponding to image 200 of FIG. 2A, as displayed or recorded by video recorder 114 of FIG. 1.

As shown in FIG. 3A, first image 300 includes: an image portion 302, which corresponds to subject 104 of FIG. 1 and which corresponds to image portion 202 of FIG. 2A; and an image portion 304, which corresponds to fan 106 of FIG. 1, and which corresponds to image portion 204 of FIG. 2A. Image portion 304 includes image portions 306, 308 and 310, which correspond to fan blades 110, 112 and 108, respectively of FIG. 1, and which correspond to image portions 206, 208 and 210, respectively, of FIG. 2A. Still further, image portion 306 includes reference objects 312, 314 and 316, which correspond to reference objects 212, 214 and 216, respectively, of FIG. 2A.

In the first frame of video being recorded, fan blades 108, 110 and 112 are in a first position. As shown in FIG. 4, motion estimate portion 404 chooses objects of reference, upon which estimates of any movement of the hand of videographer 102 will be based. In the case of this example, motion estimate portion 404 chooses reference objects 212, 214 and 216 as the objects of reference.

It should be noted that first image 300 of FIG. 3A corresponds to image 200 of FIG. 2A. In other words, image portions 220 and 222 are not displayed or stored. The purpose of image window 218 is to enable image stabilization in the event that video recorder 114 moves, e.g., the hand of the videographer shakes. This will be described with reference to FIGS. 2B and 3B.

FIG. 2B illustrates a second frame corresponding to a second image 224 recorded by video recorder 114 of FIG. 1 at a time t₂.

As shown in FIG. 2B, image window 218 includes image 224, which includes an image portion 226 corresponding to subject 104 of FIG. 1 and an image portion 228 corresponding to fan 106 of FIG. 1. Image portion 228 includes image portions 230, 232 and 234, which correspond to fan blades 110, 112 and 108, respectively of FIG. 1. Still further, image portion 234 includes reference objects 236, 238 and 240. An image portion 242 corresponds to the portion of subject 104, which is disposed outside of image 224. An image portion 244 corresponds to the portion of fan 106, which is disposed outside of image 224.

For purposes of discussion, in this example, presume that video recorder 114 has moved as a result of movement of the hand of videographer 102, and further presume that subject 104 and fan blades 108, 110 and 112 have not changed position between times t₁ and t₂. Accordingly, image 224 is shifted within image window 218 of FIG. 2B relative to the position of image 200 within image window 218 of FIG. 2A. Returning to FIG. 4, motion estimate portion 404 may determine the amount of shift based on the change in position of any one of reference objects 216, 212 or 214 of FIG. 2A as compared to the position of the corresponding one of reference objects 240, 236 or 238.

As shown in FIGS. 1, and 2A-B, in the second frame of video being recorded, fan blades 108, 110 and 112 remain in the first position, as evidenced by comparing the relative positions of reference objects 212, 214 and 216 of FIG. 2A with the relative positions of position of reference objects 236, 238 and 240 of FIG. 2B. Returning to FIG. 4, motion estimate portion 404 may then compare an actual change in position of a reference object with its corresponding reference object to determine the amount of motion of video recorder 114. For purposes of discussion, presume that motion estimate portion 404 compares the actual position of reference object 216 with the actual position of reference object 240. In this example, as shown in FIG. 2B, the position of reference object 216 is moved from right-to-left in an amount Δx₁ to the position of reference object 240 and the position of reference object 216 is moved downward in an amount Δy₁ to the position of reference object 240.

Video recorder 114 may then display and or store an image corresponding to this second frame, yet processed to stabilize the image—to compensate for movement of the hand of videographer 102. This will be described with reference to FIG. 3B.

FIG. 3B illustrates a second image 318, corresponding to image 224 of FIG. 2B, as displayed or recorded by video recorder 114 of FIG. 1.

As shown in FIG. 3B, second image 318 includes: an image portion 320, which corresponds to subject 104 of FIG. 1 and which corresponds to image portion 226 of FIG. 2B; and an image portion 322, which corresponds to fan 106 of FIG. 1, and which corresponds to image portion 228 of FIG. 2B. Image portion 322 includes image portions 328, 324 and 326, which correspond to fan blades 110, 112 and 108, respectively of FIG. 1, and which correspond to image portions 234, 230 and 232, respectively, of FIG. 2B. Still further, image portion 328 includes reference objects 334, 330 and 332, which correspond to reference objects 240, 236 and 238, respectively, of FIG. 2B.

In this example, second image 318 is created by shifting image 224 of FIG. 2B from left-to-right in an amount Δx₁ and upward in an amount Δy₁. More specifically, as shown in FIG. 4, motion estimate portion 404 provides motion signal 420 to image stabilization portion 406. Presuming now that the image stabilization feature has been turned on, via actuation portion image stabilization portion 408, image stabilization portion 406 then creates second image 318. Accordingly, the change between the position of image 300 of FIG. 3A and the position of image 318 of FIG. 3B is minimized.

Image 318, the shifted version of image 224, may then be displayed on display 412 and/or stored in memory portion 410.

This conventional system and method of digitally stabilizing an image may inadvertently create image jitter if moving objects are chosen as reference objects. This will be described with reference to FIGS. 2C and 3C.

FIG. 2C illustrates a third frame corresponding to a third image 246 recorded by video recorder 114 of FIG. 1 at a time t₃.

As shown in FIG. 2C, image window 218 includes image 246, which includes an image portion 248 corresponding to subject 104 of FIG. 1 and an image portion 250 corresponding to fan 106 of FIG. 1. Image portion 250 includes image portions 256, 252 and 254, which correspond to fan blades 110, 112 and 108, respectively of FIG. 1. Still further, image portion 256 includes reference objects 262, 258 and 260. An image portion 264 corresponds to the portion of subject 104, which is disposed outside of image 246. An image portion 266 corresponds to the portion of fan 106, which is disposed outside of image 246.

For purposes of discussion, in this example, presume that video recorder 114 has moved as a result of movement of the hand of videographer 102, such that the position of image 246 within image window 218 is moved from left-to-right in an amount Δx₃ from the position of image 224 within image window 218 and such that the position of image 246 within image window 218 is moved from upward in an amount Δy₃ from the position of image 224 within image window 218. Further, presume that fan blades 108, 110 and 112 have changed position between times t₂ and t₃. Returning to FIG. 4, motion estimate portion 404 may incorrectly determine the amount of shift based on the change in position of any one of reference objects 240, 236 or 238 of FIG. 2B as compared to the position of the corresponding one of reference objects 262, 256 or 260.

In this case, motion estimate portion 404 has already determined that reference objects 240, 236 and 238 are reference objects. Motion estimate portion 404 may then compare an actual change in position of a reference object with its corresponding reference object to determine the amount of motion of video recorder 114. For purposes of discussion, presume that motion estimate portion 404 compares the actual position of reference object 240 with the actual position of reference object 262. In this example, as shown in FIG. 2C, the position of reference object 240 is moved from right-to-left in an amount Δx₂ to the position of reference object 262 and the position of reference object 240 is moved from downward in an amount Δy₂ to the position of reference object 262.

Video recorder 114 may then display and or store an image corresponding to this third frame, yet processed to stabilize the image—to compensate for movement of the hand of videographer 102. This stabilization will provide an incorrect image as a result of using a moving reference object. This will be described with reference to FIG. 3C.

FIG. 3C illustrates a third image 336, corresponding to image 246 of FIG. 2C, as displayed or recorded by video recorder 114 of FIG. 1.

As shown in FIG. 3C, third image 336 includes: an image portion 338, which corresponds to subject 104 of FIG. 1 and which corresponds to image portion 248 of FIG. 2C; and an image portion 340, which corresponds to fan 106 of FIG. 1, and which corresponds to image portion 250 of FIG. 2C. Image portion 250 includes image portions 346, 342 and 344, which correspond to fan blades 110, 112 and 108, respectively of FIG. 1, and which correspond to image portions 256, 252 and 254, respectively, of FIG. 2B. Still further, image portion 256 includes reference objects 262, 258 and 260, which correspond to reference objects 352, 348 and 350, respectively, of FIG. 2B.

In this example, third image 336 is created by shifting image 246 of FIG. 2C from right-to-left in an amount Δx₂ and upward in an amount Δy₁. More specifically, as shown in FIG. 4, motion estimate portion 404 provides motion signal 420 to image stabilization portion 406. In this case, motion signal 420 is incorrectly based on motion of moving reference objects. Accordingly, the change between the position of image 318 of FIG. 3B and the position of image 336 of FIG. 3C is drastic. If third image 336 were created by shifting image 246 of FIG. 2C from left-to-right in an amount Δx₃ and downward in an amount Δy₃, then the change would have countered the movement of video recorder 114. However, video recorder 114 incorrectly chose a moving object as a reference object. This poor choice thus created image jitter.

What is needed is a system and method for determining the motion of the user and the motion of the subject such that image stabilization is applied appropriately.

### SUMMARY OF INVENTION

Aspects of the present invention provide a system and method for determining the motion of the user and the motion of the subject such that image stabilization is applied appropriately.

Aspects of the present invention are drawn to a video device including a first video camera, a second video camera, a motion estimating portion and an image stabilization portion. The first video camera is arranged to record a first image of a first field of view at a first time and to record a second image of the first field of view at second time. The first video camera can output a first frame of image data based on the first image and can output a second frame of image data based on the second image. The second video camera is arranged to record a third image of a second field of view at a third time and to record a fourth image of the second field of view at fourth time. The second video camera can output a third frame of image data based on the third image and can output a fourth frame of image data based on the fourth image. The motion estimating portion can output a motion signal based the fourth frame of image data. The image stabilization portion can modify the second frame of image data based on the motion signal.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a scenario where a video is being recorded;

FIG. 2A illustrates a first frame corresponding to a first image recorded by the video recorder of FIG. 1 at a time t₁;

FIG. 2B illustrates a second frame corresponding to a second image recorded by the video recorder of FIG. 1 at a time t₂;

FIG. 2C illustrates a third frame corresponding to a third image recorded by the video recorder of FIG. 1 at a time t₃;

FIG. 3A illustrates a first image, corresponding to the image of FIG. 2A, as displayed or recorded by the video recorder of FIG. 1;

FIG. 3B illustrates a second image, corresponding to the image of FIG. 2B, as displayed or recorded by the video recorder of FIG. 1;

FIG. 3C illustrates a third image, corresponding to the image of FIG. 2C, as displayed or recorded by the video recorder of FIG. 1;

FIG. 4 illustrates a detailed view of the video camera of FIG. 1;

FIG. 5 illustrates a video device in accordance with embodiments of the present invention;

FIG. 6 illustrates a scenario where a video is being recorded with the device of FIG. 5;

FIG. 7a illustrates the image of the user monitored by the second video camera of FIG. 5;

FIG. 7b illustrates motion estimation of the user;

FIG. 7c illustrates face recognition of the user;

FIG. 8 illustrates a method for applying image stabilization, in accordance with embodiments of the present invention; and

FIG. 9 illustrates a method by which it is determined how much motion needs compensated for, in accordance with embodiments of the present invention.

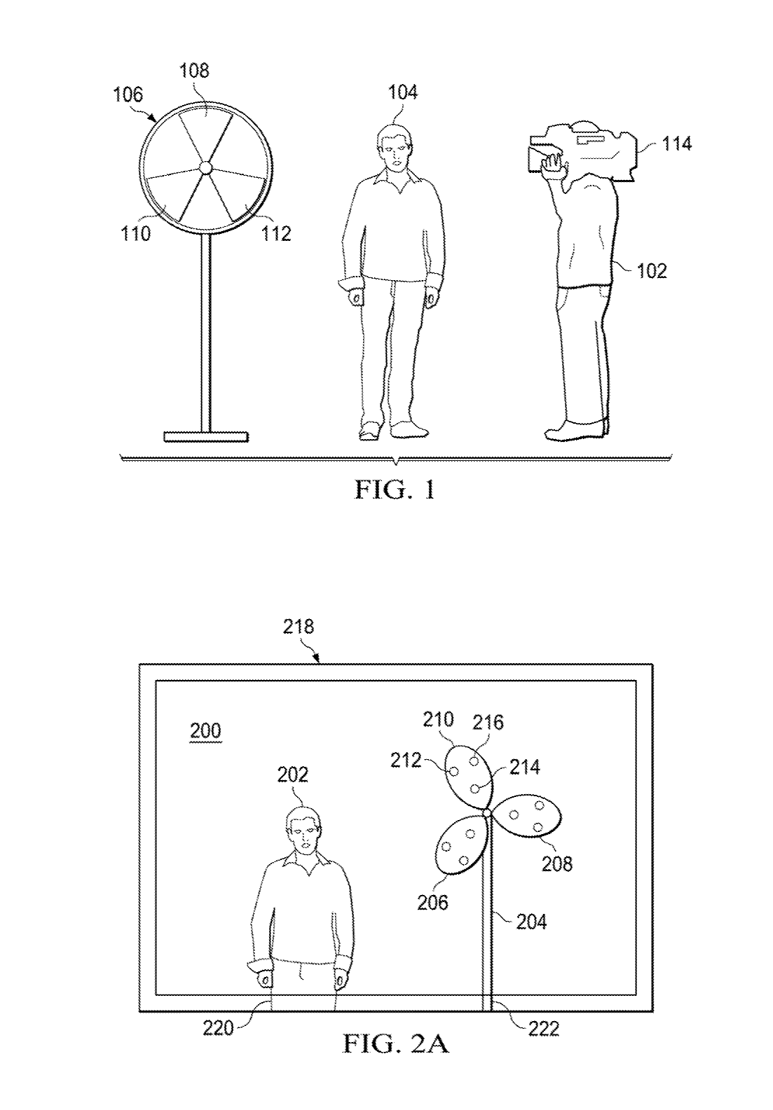

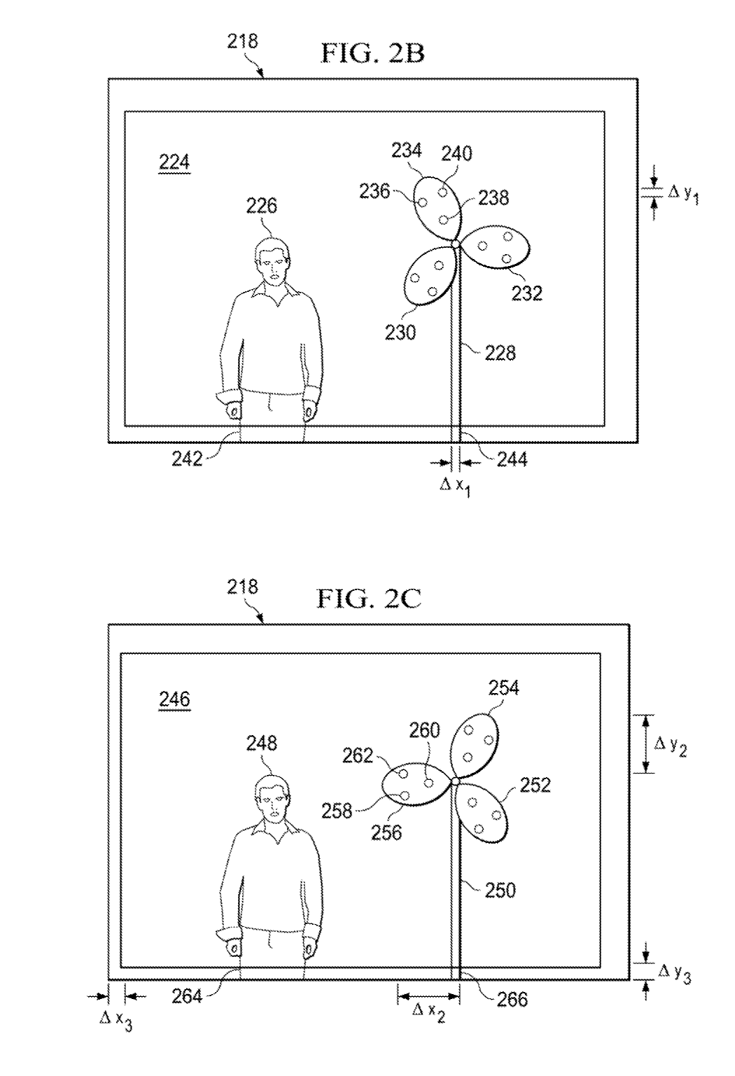

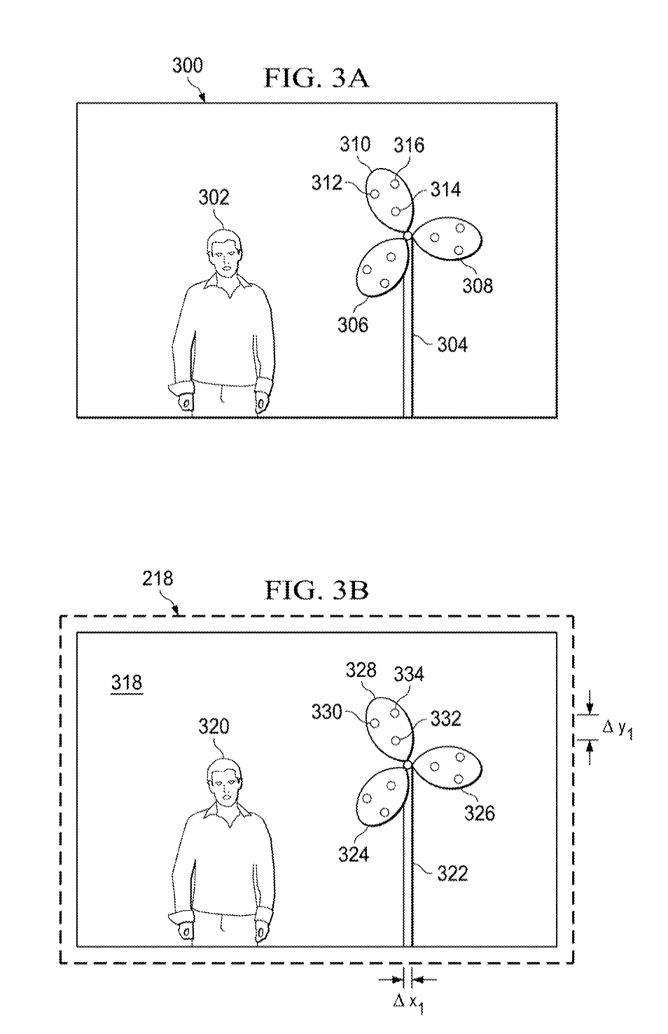

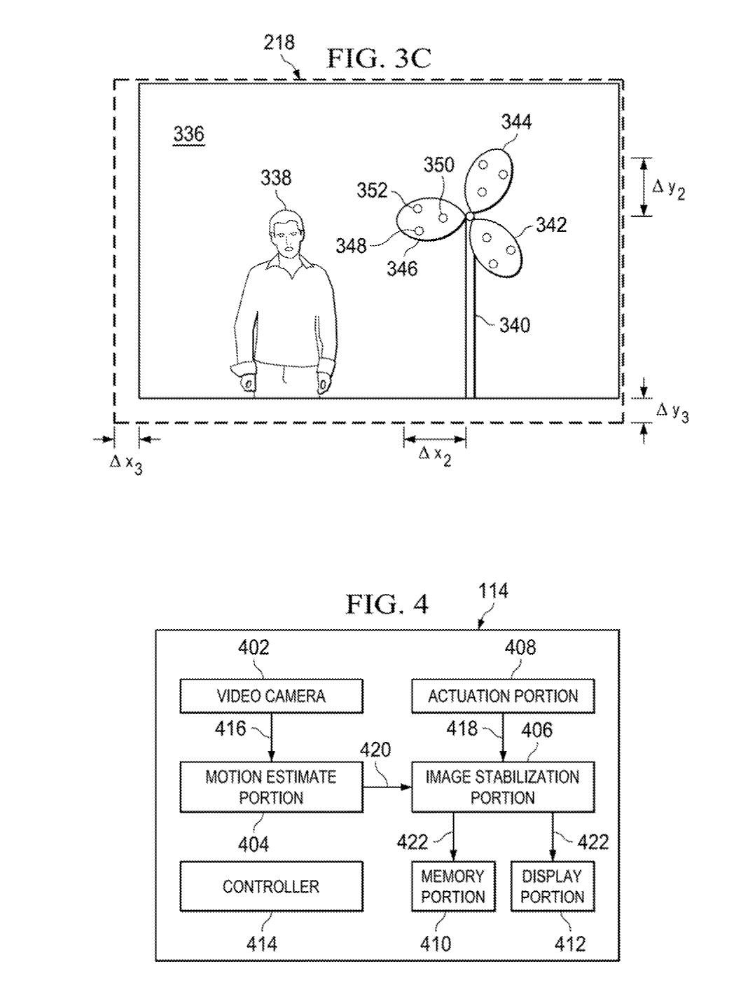

### DETAILED DESCRIPTION OF THE DRAWINGS

The present invention provides a system and method for determining the motion of a user and a subject during a video recording such that image stabilization is applied in the appropriate situation.

The system and method incorporates a recording device having two cameras. As a user positions the recording device, a first video camera is directed toward a first field of view to record the video, whereas a second video camera is directed toward a second field of view to find and track reference objects to determine motion of the recording device. In an example embodiment, the first video camera is a front-facing video camera directed toward the scene for recording, whereas the second video camera is a rear-facing video camera directed toward the face of the user to track the motion of the user's face. The tracking, performed by any known motion estimates or by incorporating face recognition hardware or software, is used to determine motion of the user's hand while recording the video.

For example, if the user is recording a video and the motion estimates determine that the user's hand is moving while recording the video, digital image stabilization may correct for that motion on the video being recorded by the first video camera. On the other hand, if the motion estimates determine that the user's hand is not moving, it is presumed that the motion is entirely within the scene being recorded, and image stabilization would not be employed.

In some cases, the first and second video cameras may be facing directions 180-degrees opposite of each other, however it is not required to execute the present invention. The first and second cameras may be configured in any orientation that provides the ability to determine motion of the video recorder.

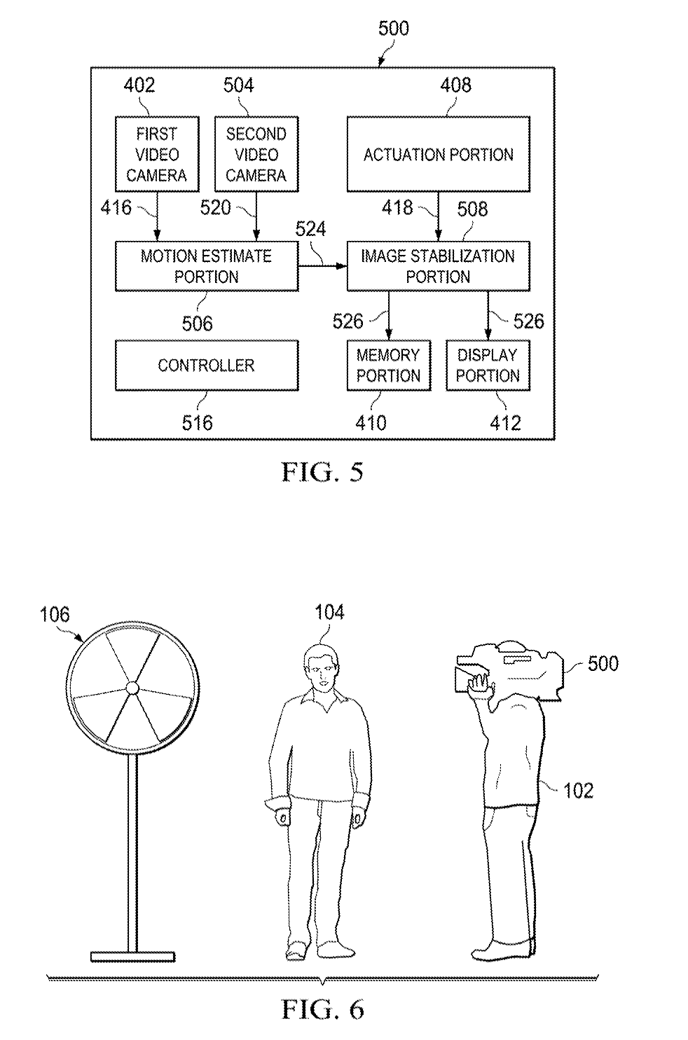

Detailed descriptions of example embodiments will now be described with reference to FIGS. 5-9.

FIG. 5 illustrates a video device in accordance with embodiments of the present invention.

As shown in the figure, video device 500 includes first video camera 402, a second video camera 504, a motion estimate portion 506, an image stabilization portion 508, actuation portion 408, memory portion 410, display portion 412 and a controller 516. In this example, first video camera 402, second video camera 504, motion estimate portion 506, image stabilization portion 508, actuation portion 408, memory portion 410, display portion 412 and controller 516 are distinct elements. However, in some embodiments, at least two of first video camera 402, second video camera 504, motion estimate portion 506, image stabilization portion 508, actuation portion 408, memory portion 410, display portion 412 and controller 516 may be combined as a unitary element. In other embodiments, at least one of motion estimate portion 506, image stabilization portion 508, actuation portion 408, memory portion 410 and controller 516 may be implemented as a computer having stored therein non-transient, tangible computer-readable media for carrying or having computer-executable instructions or data structures stored thereon.

Video device 500 may be any device that includes multiple cameras to record video. In an example embodiment, video device 500 is a mobile phone with a front facing camera and a rear facing camera, where the two cameras face in opposite directions. Those skilled in the art will understand that other devices (tablet computers, handheld camcorders, etc.) may include multiple cameras. In addition, those skilled in the art will understand that the two cameras do not necessarily need to face in completely opposite directions to properly execute the present invention.

Second video camera 504 may be any type of camera designed to capture video. First video camera 504 may be preferably small enough to fit in a device like a mobile phone, such that the user does not have to carry a video recording device separate from a mobile phone. In an example embodiment, first video camera 504 may be a CMOS camera similar to those used in mobile phones.

First video camera 402 and second video camera 504 may record videos at the same resolution, but they may also record videos at different resolutions. In an example embodiment, first video camera 402 is intended to record videos of subjects and requires a relatively high resolution, while second video camera 504 is intended to provide feedback regarding motion of a user recording the video and thus requires relatively low resolution.

Motion estimate portion 506 is arranged to receive image data 518 from first video camera 402 and image data 520 from second video camera 504. Motion estimate portion uses image data 518 and image data 520 to determine if image stabilization may be required. The motion may be estimated by any conventional motion estimation methods, including direct methods or algorithms (block-matching, phase correlation, pixel recursive, MAP/MRF, optical flow) and indirect methods or algorithms (corner detection, face recognition). Based on image data 518 and 520, motion estimate portion 506 will create motion signal 524 and send it to image stabilization portion 508.

Image stabilization portion 508 is arranged to receive motion signal 524 from motion estimate portion 506. Motion signal 524 will provide input to image stabilization portion 508 and based on the input, image stabilization portion 508 will either attempt to stabilize the video being recorded or not stabilize the video being recorded. Image stabilization portion 508 may use any conventional methods know by those of ordinary skill in the art to stabilize the video, such as optical image stabilization, sensor-shift, digital image stabilization and stabilization filters. Once image stabilization portion 508 has completed the stabilization process, stabilized video 526 may be sent to both memory portion 410 and display portion 412.

Memory portion 410 is arranged to communicate with image stabilization portion 508 and receive stabilized video 526 for future viewing by the user. Non limiting examples of memory portion 410 include RAM, ROM, EEPROM, CD-ROM or other optical disk storage, magnetic disk storage or other magnetic storage devices, or any other medium which can be used to carry or store desired program code means in the form of data structures which can be accessed by a general purpose or special purpose computer.

Display portion 412 is arranged to communicate with image stabilization portion 508 and receive stabilized video 526 for viewing while the video is being recorded. Non-limiting examples of display portion 412 include a mobile phone screen, tablet computer screen, television, laptop or desktop computer screen, or any other device which has the capability of displaying the video as it is recorded on video device 800.

Controller 516 is arranged to bidirectionally communicate with each of first video camera 402, second video camera 504, motion estimate portion 506, image stabilization portion 508, actuation portion 408, memory portion 410 and display portion 412. Controller 516 may receive instructions from the user via a graphical user interface (GUI), and pass the instructions from the user to each of the portions of video device 500.

Video device 500 and all of the portions included therein will be further described with reference to FIGS. 6-8.

FIG. 6 illustrates a scenario where a video is being recorded with the device of FIG. 5.

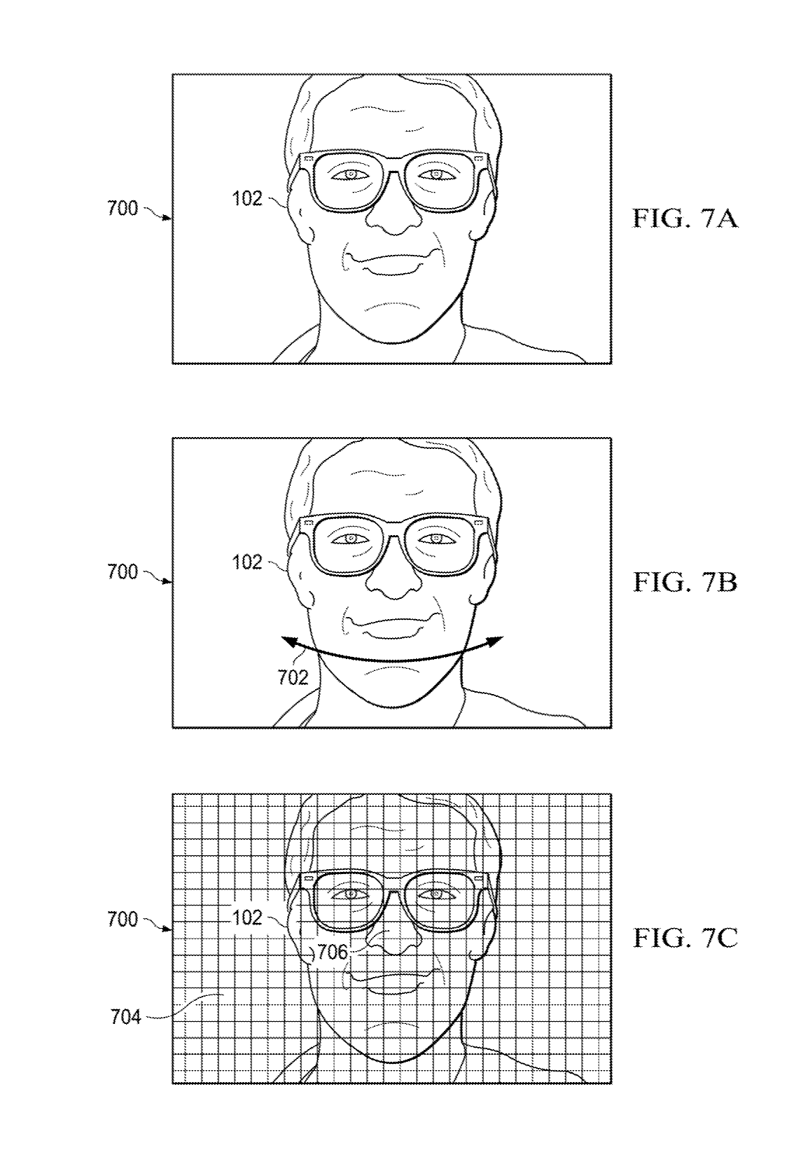

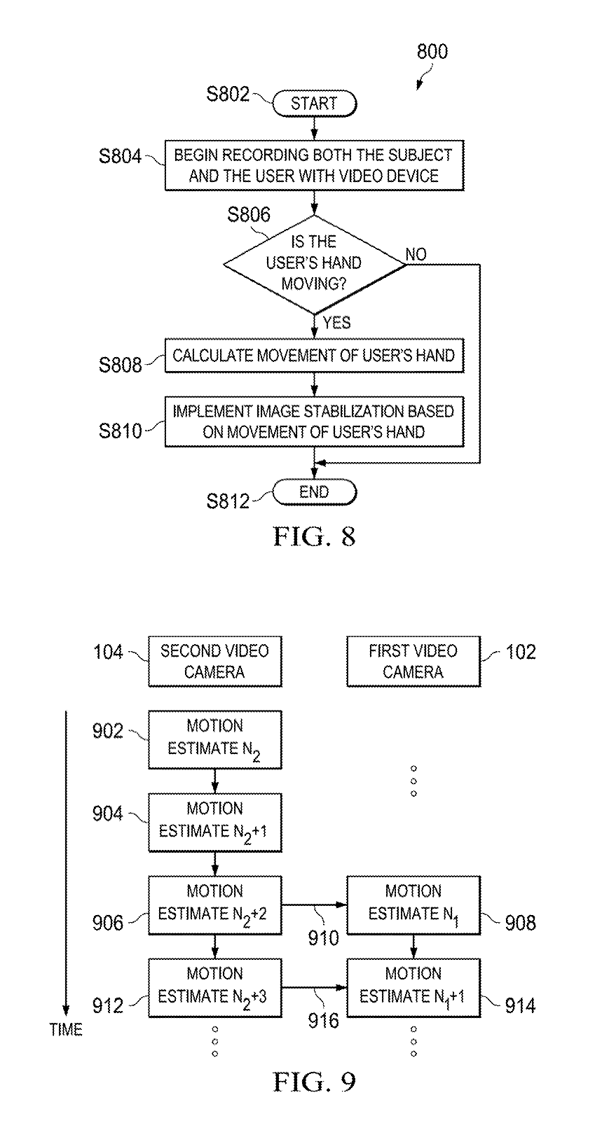

As shown in the figure, user 102 is holding video device 500. User 102 is recording a video of subject 104 directly in front of user 102 by using first video camera 402 (not shown), which is the front facing camera. Second video camera 504 (not shown) is pointed toward user 102, such that first video camera 402 and second video camera 504 are pointed in directions 180-degrees from one another. Fan 106 is in the background of the video being recorded, however the spinning blades of fan 106 will not impact the determination of whether or not the hand of user 102 is moving while recording the video. This will be further described with reference to FIGS. 7-8.

FIG. 7A illustrates the image of the user monitored by the second video camera of FIG. 5.

As shown in FIG. 7A, scene 700 includes user 102. Scene 700 is what second video camera 504 (not shown) captures when user 102 chooses to record the video from FIG. 6. As discussed above, second video camera 102 may be activated in order to determine whether image stabilization may be applied to the video captured via first video camera 402. Methods of making this determination will be further described with reference to FIGS. 7B-C.

FIG. 7B illustrates motion estimation of the user.

As shown in the figure, scene 700 includes user 102. In order to determine whether image stabilization may be applied to the video captured via first video camera 402, the motion of user 102 is monitored for changes. For example, in one frame, the image of the user may be in a first position within the field of view, whereas in the following frame, the image of the user may be in a second position within the field of view that is different than the first position. The position difference between the first position and second position may be calculated, and if the determination is made that the second position of the user is sufficiently different from the first position, image stabilization may be applied. In the figure, the face of user 102 is moving along the along arc 702 indicated by the arrow, which may necessitate image stabilization to avoid a blurry or “jerky” video. This type of motion estimation is one form of motion detection well known to those of ordinary skill in the field of digital imaging, so further details will not be provided.

FIG. 7C illustrates face recognition of the user.

As shown in the figure, scene 700 includes user 102, a grid 704 and a center 706. Grid 704 to is applied to scene 700 being monitored by second video camera 504. Center 706 is the approximate center of the face of user 102 and its position is monitored in order to determine whether image stabilization may be applied to the video captured via first video camera 402. For example, center 706 would be monitored in sequential video frames. The position of center 706 relative to grid 704 would be compared from frame to frame, and when the difference in position of center 706 between frames is large enough, image stabilization may be applied. This type of face recognition is one form of motion detection well known to those of ordinary skill in the field of digital imaging, so further details will not be provided.

In addition to the methods discussed above, any known method of determining the motion of the user may be employed. The motion of the user described above refers to a user's hand moving while recording a video. If the user's hand is moving, then the user's face, which is being monitored for motion, would move within the field of view of the camera monitoring the user's face. In a typical scenario, the user's face will remain relatively stationary, such that any motion of the user's face within the field of view of the camera can be attributed to movement of the user's hand.

FIG. 8 illustrates a method 800 for applying image stabilization, in accordance with embodiments of the present invention.

As shown in the figure, method 800 starts (S802) and a user begins recording with a video device (S804).

Returning to FIGS. 5-6, user 102 decides that he wishes to record a video, so he holds video device 500 up and initiates video recording via the GUI that is connected to controller 516. Controller 516 then instructs first video camera 402 to begin recording. Controller 516 also instructs second video camera 504 to begin recording scene 700 to monitor the position of the face of user 102. Image data 518 and 520 that is recorded by first video camera 402 and second video camera 504, respectively, is sent to motion estimate portion 506.

Returning to FIG. 8, it is determined whether the user's hand is moving (S806).

With reference to FIGS. 7A-C, motion estimate portion 506 then determines if the hand of user 102 is moving. In the case where video device 500 uses motion estimation, motion estimate portion 506 may determine that user 102 is moving along arc 702 by comparing the position of the user in consecutive video frames being monitored. Alternatively, in the case where video device 500 uses face recognition, motion estimation portion 506 may determine that center 706 is moving relative to grid 704 by comparing the position of center 706 in consecutive video frames being monitored. In either case, motion estimate portion 506 would determine that the face of user 102 is moving, which would indicate that the hand of user 102 is moving.

Returning to FIG. 8, it has been determined that the user's hand is moving (YES at S806), and then the movement of the user's hand may be calculated (S808).

With reference to FIGS. 7A-C, and depending on the type of motion determination being used, the amount of motion of the user's hand will be calculated by using any method of motion calculation known to those of ordinary skill in the art.

Returning to FIG. 8, image stabilization will then be implemented (S810).

Referring now to FIG. 5, motion estimate portion 506 will subtract the amount of motion calculated in S808 from any other residual motion to determine how to appropriately compensate for the motion of the user's hand. Subtracting the calculated motion may be accomplished by using any method known to those of ordinary skill in the art. The net amount of motion is converted to motion signal 524 and sent to image stabilization portion 508. Image stabilization portion 508 takes the input of motion signal 524 and applies the appropriate algorithm to stabilize the video being recorded from first video camera 402. Stabilized video 526 is then sent to memory portion 410 for future viewing, and it may be also sent to display portion 412 for viewing while the video is being recorded by first video camera 402.

Returning to FIG. 8, method 800 ends (S812).

Returning now to S806, it may be determined that the user's hand is not moving (NO at S806). In that case, no image stabilization is implemented and method 800 ends S812.

FIG. 9 illustrates a method by which it is determined the amount of motion for which compensated may be required, in accordance with embodiments of the present invention.

As shown in the figure, motion estimates 902-906 and 912 are associated with second video camera 504, and motion estimates 908 and 914 are associated with first video camera 402. Motion estimates 902-906 and 912 may include standard motion estimation, face recognition or positioning algorithms, or any other method by which motion of the user's face may be tracked.

The method begins with a user attempting to record a video via first video camera 402. Before video is recorded via first video camera 402, second video camera 504 is activated and motion estimate 902 is made for frame N₂ regarding how much the user's hand is moving at that time. Motion estimate 904 is made for the next frame, N₂₊₁, and motion estimate 906 is made for the subsequent frame, N₂₊₂.

Video begins recording from first video camera 402 after second video camera 504 has been monitoring the user's face for three frames. Using the information compiled from those 3 frames, feedback 910 may be provided, which will influence motion estimate 908. Feedback 910 includes data regarding motion estimates 902-906, which will provide a much quicker and more accurate way to predict how much motion can be compensated for when stabilizing the video being recorded from first video camera 402. This method may also aid in reducing the level of computational complexity typically used when determining the proper amount of image stabilization required.

At the next frame for second video camera 504 (frame N₂₊₃), motion estimate 912 may be made, and feedback 916 may be provided. Feedback 916 includes data compiled from the first 4 frames, and will influence motion estimate 914.

As time goes on, this process will continue to provide information that can be used to better predict the amount of image stabilization that will be required for the video being recorded by first camera 402 until the user decides to stop recording the video via first video camera 402.

In summary, conventional devices and methods that provide image stabilization typically utilize landmarks or objects of reference in the video being recorded to determine whether or not image stabilization may be required. These methods are not always accurate, though, and sometimes have difficulty in determining when to apply image stabilization, resulting in distorted videos.

The present invention provides a device and method to provide image stabilization by using one camera to record the desired video, and a second camera to monitor the position of the face of the user who is recording the video. Relative motion of the face of the user within the field of view of the second camera will indicate how much the user's hand is moving while recording the video, and thus whether or not image stabilization is required.

The benefit of the present invention is that the decision as to when to implement image stabilization is no longer based on the video being recorded, but on the user recording the video. With each camera having a specific responsibility, errors in determining when to implement image stabilization will be greatly reduced.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A video device comprising:
a first video camera arranged to record a first image of a first field of view at a first time and to record a second image of the first field of view at second time and is operable to output a first frame of image data based on the first image and to output a second frame of image data based on the second image;
a second video camera arranged to record a third image of a second field of view at a third time and to record a fourth image of the second field of view at fourth time and is operable to output a third frame of image data based on the third image and to output a fourth frame of image data based on the fourth image;
a motion estimate portion operable to output a motion signal based the fourth frame of image data; and
an image stabilization portion operable to modify the second frame of image data based on the motion signal.

2. The video device of claim 1,
wherein the first video camera is operable to output the first frame of image data with a first resolution,
wherein the second video camera is operable to output the third frame of image data with a second resolution, and
wherein the first resolution is greater than the second resolution.

3. The video device of claim 1,
wherein said first video camera is arranged such that the first field of view is in a first direction,
wherein said second video camera is arranged such that the second field of view is in a second direction, and
wherein the first direction is opposite to the second direction.

4. The video device of claim 1,
wherein the first time is different than the third time, and
wherein the second time is different than the fourth time.

5. The video device of claim 4,
wherein the first time is after the third time, and
wherein the second time is after the fourth time.

6. The video device of claim 1, wherein said motion estimate portion includes a face recognition portion operable to detect a face of a user.

7. A method comprising:
recording, via a first video camera, a first image of a first field of view at a first time;
recording, via the first video camera, a second image of the first field of view at second time;
outputting, via the first video camera, a first frame of image data based on the first image;
outputting, via the first video camera, a second frame of image data based on the second image;
recording, via a second video camera, a third image of a second field of view at a third time;
recording, via the second video camera, a fourth image of the second field of view at fourth time;
outputting, via the second video camera, a third frame of image data based on the third image;
outputting, via the second video camera, a fourth frame of image data based on the fourth image;
outputting, via a motion estimate portion, a motion signal based the fourth frame of image data; and
modifying, via an image stabilization portion, the second frame of image data based on the motion signal.

8. The video device of claim 7,
wherein said outputting, via the first video camera, a first frame of image data based on the first image comprises outputting the first frame of image data with a first resolution,
wherein said outputting, via the second video camera, a third frame of image data based on the third image comprises outputting the third frame of image data with a second resolution, and
wherein the first resolution is greater than the second resolution.

9. The video device of claim 7,
wherein said recording, via a first video camera, a first image of a first field of view at a first time comprises recording via the first video camera as arranged such that the first field of view is in a first direction,
wherein said recording, via a second video camera, a third image of a second field of view at a third time comprises recording via the second video camera as arranged such that the second field of view is in a second direction, and
wherein the first direction is opposite to the second direction.

10. The video device of claim 7,
wherein said recording, via a second video camera, a third image of a second field of view at a third time comprises recording, via the second video camera, such that the first time is different than the third time, and
wherein said recording, via the second video camera, a fourth image of the second field of view at fourth time comprises recording, via the second video camera, such that the second time is different than the fourth time.

11. The video device of claim 10,
wherein said recording, via the second video camera, such that the first time is different than the third time comprises recording, via the second video camera, such that the first time is after the third time, and
wherein said recording, via the second video camera, such that the second time is different than the fourth time comprises recording, via the second video camera, such that the second time is after the fourth time.

12. The video device of claim 7, wherein said outputting, via a motion estimate portion, a motion signal based the fourth frame of image data comprises detecting, via a face recognition portion, a face of a user.

13. A non-transitory, tangible, computer-readable media having computer-readable instructions stored thereon, the computer-readable instructions being capable of being read by a computer and being capable of instructing the computer to perform the method comprising:
recording, via a first video camera, a first image of a first field of view at a first time;
recording, via the first video camera, a second image of the first field of view at second time;
outputting, via the first video camera, a first frame of image data based on the first image;
outputting, via the first video camera, a second frame of image data based on the second image;
recording, via a second video camera, a third image of a second field of view at a third time;
recording, via the second video camera, a fourth image of the second field of view at fourth time;
outputting, via the second video camera, a third frame of image data based on the third image;
outputting, via the second video camera, a fourth frame of image data based on the fourth image;
outputting, via a motion estimate portion, a motion signal based the fourth frame of image data; and
modifying, via an image stabilization portion, the second frame of image data based on the motion signal.

14. The non-transitory, tangible, computer-readable media of claim 13,
wherein the computer-readable instructions are capable of instructing the computer to perform the method such that said outputting, via the first video camera, a first frame of image data based on the first image comprises outputting the first frame of image data with a first resolution,
wherein the computer-readable instructions are capable of instructing the computer to perform the method such that said outputting, via the second video camera, a third frame of image data based on the third image comprises outputting the third frame of image data with a second resolution, and
wherein the computer-readable instructions are capable of instructing the computer to perform the method such that the first resolution is greater than the second resolution.

15. The non-transitory, tangible, computer-readable media of claim 13,
wherein the computer-readable instructions are capable of instructing the computer to perform the method such that said recording, via a first video camera, a first image of a first field of view at a first time comprises recording via the first video camera as arranged such that the first field of view is in a first direction,
wherein the computer-readable instructions are capable of instructing the computer to perform the method such that said recording, via a second video camera, a third image of a second field of view at a third time comprises recording via the second video camera as arranged such that the second field of view is in a second direction, and
wherein the computer-readable instructions are capable of instructing the computer to perform the method such that the first direction is opposite to the second direction.

16. The non-transitory, tangible, computer-readable media of claim 13,
wherein the computer-readable instructions are capable of instructing the computer to perform the method such that said recording, via a second video camera, a third image of a second field of view at a third time comprises recording, via the second video camera, such that the first time is different than the third time, and
wherein the computer-readable instructions are capable of instructing the computer to perform the method such that said recording, via the second video camera, a fourth image of the second field of view at fourth time comprises recording, via the second video camera, such that the second time is different than the fourth time.

17. The non-transitory, tangible, computer-readable media of claim 16,
wherein the computer-readable instructions are capable of instructing the computer to perform the method such that said recording, via the second video camera, such that the first time is different than the third time comprises recording, via the second video camera, such that the first time is after the third time, and
wherein the computer-readable instructions are capable of instructing the computer to perform the method such that said recording, via the second video camera, such that the second time is different than the fourth time comprises recording, via the second video camera, such that the second time is after the fourth time.

18. The non-transitory, tangible, computer-readable media of claim 13, wherein the computer-readable instructions are capable of instructing the computer to perform the method such that said outputting, via a motion estimate portion, a motion signal based the fourth frame of image data comprises detecting, via a face recognition portion, a face of a user.
